(19) United States
(12) Patent Application Publication
(10) Pub. No.: US 2026/0364610 A1
(43) Pub. Date: Nov. 19, 2026

(54) APPARATUS AND PROCESS FOR CONTINUOUS SEPARATION OF A PLASTICS MIXTURE

(71) Applicant: MONTANUNIVERSITÄT LEOBEN, Leoben (AT)

(72) Inventors: Franz GRASSEGGER, Kapfenberg (AT); Michael FEUCHTER, Leoben (AT); Nadine WILD, Lochau (AT)

(21) Appl. No.: 19/133,527

(22) PCT Filed: Nov. 23, 2023
(86) PCT No.: PCT/EP2023/082789

§ 371 Date: May 28, 2025

(30) Foreign Application Priority Data
Nov. 29, 2022 (AT) A50907/2022

(51) Int. Cl. B04B 1/02; B04B 1/20; B04B 15/02; C08J 11/06

(52) U.S. Cl. CPC B04B 1/02; B04B 1/20; B04B 15/02; C08J 11/06; B04B 2001/2083

(57) ABSTRACT

A device for separating a plastic mixture is described, the device comprising:
i) a supply region which is configured to supply a plastic mixture in an at least partially molten state;
ii) a centrifuging region which is coupled to the supply region and which is configured to separate the at least partially molten plastic mixture by centrifuging into a first plastic fraction and a second plastic fraction, wherein the first plastic fraction is different from the second plastic fraction; and
iii) a discharge region which is coupled to the centrifuging region and which is configured to provide the separated first plastic fraction and the separated second plastic fraction.

The device is configured to operate in a continuous operation.

This application is a national US phase of PCT/EP2023/082789 which claims the benefit of the filing date of Austrian Patent Application No. A 50907/2022 filed 29 Nov. 2022, the disclosure of which is hereby incorporated herein by reference.

### TECHNICAL FIELD

The disclosure concerns a device for separating a (molten) plastic mixture, which comprises a feed region, a centrifuging region and a discharge region. Further, the disclosure concerns a method for separating a (molten) plastic mixture.

Accordingly, the disclosure may concern the technical field of separating plastic fractions from a plastic mixture.

### TECHNICAL BACKGROUND

Recycling of plastics is a current (research) topic of considerable economic and environmental relevance. A large number of methods are in use and development worldwide. A particular problem may consist in efficiently recycling a plastic mixture, because different plastics may require different processing processes depending on their nature. This in particular applies when it is a non-sortable plastic mixture, such as, for example, a multilayer film. At this point, special technical developments may be necessary in order not only to achieve a proper separation, but also to make this possible within economic framework with regard to costs. In Europe, about 17.8 Mt of used packaging were collected in 2018, of which only 7.5 Mt were recycled. Thus, there would be a potential of more than 10 Mt/a for new separation methods.

Current research work in the field of recycling goes in the direction of processing the material flows; for example, research is carried out on multi-sensor-supported sorting systems with artificial intelligence or so-called tracing systems. These researches aim at generating material flows of the same type in order to subsequently return them to the circuit via the conventional recycling route. However, these methods may have a great disadvantage: they usually fail in the case of material composites, such as multilayer films or polymer alloys. In order to make this waste category, which is large in terms of quantity, usable again in terms of materials, new concepts for processing may be necessary.

A separation method differs in an essential point from existing recycling methods: the separation of plastic mixtures takes place in a molten state of the polymers. Scientific work has shown that the sorting of two different polymers in the molten state functions in a centrifuge due to different physical properties (in particular the density) of the fractions in the centrifugal field. Such a method works discontinuously, or batch-wise: a plastic mixture batch is added to a centrifuge and then molten by means of temperature increase or heat supply. The subsequent use of the centrifuge enables a density separation of the plastic fractions of the plastic mixture. These fractions are then cooled, removed, and the centrifuge is prepared for a further plastic mixture batch.

However, this method may have the disadvantage that it is relatively time-consuming and enables only a low throughput in the case of the high volume of plastic mixtures in terms of waste quantities.

### SUMMARY OF THE DISCLOSURE

There may be a need to enable a separation of a plastic mixture in an efficient and reliable manner and with a high throughput.

A device and a method according to the independent claims are provided.

Advantageous embodiments are described by the dependent claims.

According to a first aspect of the disclosure, a device for separating a (at least partially molten) plastic mixture is described. The device comprising:
i) a supply region (e.g. a continuous conveying device such as a conveying screw) which is configured to supply the plastic mixture in an (at least partially) (molten) state;
ii) a centrifuging region (e.g. an elongated tubular centrifuge) which is coupled to the supply region (e.g. connected via a flange) and which is configured to separate the at least partially molten plastic mixture by centrifuging into a plastic fraction and at least one further plastic fraction (based on different physical properties, in particular density differences, viscosity differences, etc.), wherein the plastic fraction is different from the at least one further plastic fraction (in particular chemically or physically different, further in particular different at least in the specific density) (e.g. polyethylene and polyester); and
iii) a discharge region (e.g. a sieve plate or lateral openings of the centrifuge wall) which is coupled to the centrifuging region and which is configured to provide the separated (at least partially molten, substantially liquid) plastic fraction and the separated at least one further plastic fraction(s) (at least partially molten, substantially liquid).

The device is preferably configured to operate in a continuous operation (i.e. no discontinuous, batch-wise operation).

According to a second aspect of the disclosure, a method (for separating a plastic mixture, e.g. by means of a device as explained above) is described, which comprises:
i) at least partially melting a plastic mixture;
ii) centrifuging the at least partially molten plastic mixture and thereby separating the molten plastic mixture into a plastic fraction and at least one further plastic fraction,
wherein the plastic fractions differ from one another (physically and/or chemically); and
iii) discharging the separated plastic fraction and the separated at least one further plastic fraction.

The method can be operated continuously.

In the context of the present document, the term “plastic mixture” may relate to a material which comprises at least two types of plastics, or plastic fractions. For example, the plastic mixture may comprise polyethylene and polystyrene. In an example, the plastic (fractions) are not sortable or not manually separable. Examples of such a mixture may be a multilayer film or a polymer alloy. In this context, the term “plastic” may denote a synthetic material (in particular a raw material (German: Werkstoff)) which substantially consists of macromolecules (in particular carbon-based), i.e. of polymers. In colloquial terms, plastics (German: Kunststoffe) may also be referred to as synthetic plastic (German:

Plastik). In the present context, plastics may comprise thermoplastics, thermosetting plastics and elastomers. Specific examples may comprise: polyethylene terephthalate (PET), polypropylene (PP), polyethylene with high (HDPE) or low (LDPE) density, polystyrene (PS), polyvinyl chloride (PVC). In an example, the plastic mixture may comprise only one type of plastic (e.g. PE), which, however, can be separated into two or more plastic fractions (e.g. LDPE and HDPE).

In the context of the present document, the term “at least partially molten” may relate in particular to a molten state.

In the context of the present document, the term “feed region” may relate in particular to a device which is suitable for continuously providing molten plastic mixture to a centrifuging region. In a simple embodiment, the feed region may be the input region (upstream in the process direction) of a centrifuging device. In a more complex embodiment, the feed region may comprise a conveying device which can transport the molten plastic mixture by means of a continuous flow. In an example, the feed region is a separate device which is connected to a centrifuging device.

In the context of the present document, the term “centrifuging region” may relate in particular to a device which is suitable for exerting a centrifugal force on a material to be centrifuged, in particular a plastic mixture. Preferably, the centrifuging region is suitable for receiving an (at least partially molten) plastic mixture and centrifuging it by means of rotation. The rotation (uniform circular movement) of the material to be centrifuged results in a substance separation which can be used in particular to separate a plastic mixture into plastic fractions. The centrifuging region may comprise a centrifuging device which comprises one (e.g. in the case of a configuration as a tube) or more (e.g. in the case of an angular configuration) side walls which delimit an interior space in which the material to be centrifuged can then be received. The centrifuging region is preferably coupled to a supply region and to a discharge region, such that a continuous supply and discharge of material flows is made possible. The rotation of the centrifuging region can be accomplished by means of a drive device, e.g. a motor. A corresponding coupling of the drive device to the centrifuging device can take place e.g. via the discharge region. In a preferred exemplary embodiment, the centrifuging region is configured and suitable for being operated within a furnace.

In the context of the present document, the term “discharge region” may relate in particular to a device which is suitable for continuously discharging (molten) plastic fractions from a centrifuging region. In a simple embodiment, the discharge region may be the output region (downstream in the process direction) of a centrifuging device. In a more complex embodiment, the discharge region may comprise openings which are formed such that different plastic fractions can be discharged separately from one another through different (e.g. with respect to the position or the size) openings. In an embodiment, the centrifuging device may be formed to be elongate, wherein the openings may be provided downstream in the process direction and perpendicular to the elongate main extension direction (e.g. bottom of a tube), e.g. as a sieve plate. In a further embodiment, the discharge region may be a part of the centrifuging device or a part of the centrifuging region, wherein e.g. the openings may be provided in a side wall of the centrifuging device.

According to an exemplary embodiment, the disclosure may be based on the idea that an efficient and reliable separation of a plastic mixture with a high throughput is achieved when continuously molten plastic mixture is fed to a centrifuging region, and different (molten) plastic fractions continuously separated downstream in the process direction are discharged and provided.

The continuously operating centrifuging region (with additional structures) may enable mixed plastic fractions to be separated into material flows of the same type. Currently discharged, unseparated material flows can then be received again in the material circuit in the future with the presented method due to the separation and can be reused separately. Although the previous batch-wise procedure works reliably, it has disadvantages with regard to throughput and thus cost-effectiveness.

It was now surprisingly recognized by the inventors that a significantly higher throughput with (substantially) the same reliability is possible by means of a continuous operation, in which the plastic mixture is already supplied in the molten state to the centrifuging and continuously molten separated plastic fractions are discharged.

### EXEMPLARY EMBODIMENTS

According to an embodiment, the device further comprises:
a heating device, in particular a furnace. In an example, the centrifuging region is at least partially (in particular completely) arranged within the furnace. This may have the advantage that a desired temperature can be provided directly (and homogeneously) to the centrifuging region or the at least partially molten plastic mixture. In particular, the (at least partially molten) plastic mixture can thereby be kept in a certain temperature range. This in turn may have the advantage that the plastic mixture does not harden or cools down too quickly. In an embodiment, the feed region and/or discharge region are arranged outside the furnace. In a further example, the feed region and/or discharge region are at least partially arranged within the furnace.

In an embodiment, the heating device is configured to heat the centrifuge, the gases and/or the plastic mass within the centrifuge. In a further embodiment, the heating device may also be an energy source in the environment of the centrifuge, e.g. solar, an incineration plant, etc.

In a further example, the heating device may be configured as an induction heating device for eddy-current heating of ferrous, induction-capable centrifuges.

According to a further embodiment, the heating device is configured to provide a temperature within the centrifuging region such that the melting state of the molten plastic mixture is maintained. The relevant temperature may be e.g. 150 °C or more, in particular 300 °C or more. The heating device may provide or maintain the temperature to the environment, the air or the plastic melt.

This may have the advantage that an individual temperature can be set depending on which plastic mixture is used or to what degree it is to be molten during the centrifuging.

The term “temperature” may represent a room temperature, wall temperature or a thermal energy supply, in particular for sufficient melt heating or for compensating for heat losses in the supplied mass flow of the plastic mixture which is at most already present as (partially) molten material. In a further example, thermal energy sources can be used in the environment, e.g. by combustion gases from non-recyclable substances in the environment of the use.

According to a further embodiment, the device further comprises: a heating device which is configured to heat at least a part of the side wall of the centrifuging region. It has been shown that material in the outer region of the centrifuge, or in the vicinity of the side wall, tends to cool down more quickly (and thereby harden). This can be prevented efficiently and in a targeted manner in that corresponding side wall regions are additionally or alternatively heated.

According to a further embodiment, the device comprises a drive device (e.g. a motor) which is configured to drive the centrifuging region (or to enable the rotation). In one embodiment, the drive device can be coupled to the centrifuging region by means of a drive shaft. In a further example, the drive shaft runs at least partially through the discharge region. In an example, the drive device is arranged outside, in another example within the furnace.

According to a further embodiment, the device comprises a cooling device, in particular associated with a coupling region between centrifuging region and drive device (in particular via the discharge region). In particular when using the furnace described above, the temperature can become critical for the drive device. A corresponding cooling device (e.g. by means of cooling liquid) can enable an efficient and reliable operation.

According to a further embodiment, the supply region comprises a conveying device, in particular an extruder (e.g. a single-or twin-screw extruder, co-or counter-rotating extruder, etc.) which is configured to continuously add the at least partially molten plastic mixture to the centrifuging region. In this context, a conveying device may denote a device which is suitable for transporting an (at least partially molten) plastic mixture to the centrifuging region. A conveying device may be suitable for this purpose. In a further example, a conveyor belt may also be used (which is suitable for the at least partially molten plastic). The conveying device may be regarded as part of the supply region and open into the interior of the centrifuging region via a transition region.

According to a further embodiment, the centrifuging region is configured to be elongate with a main extension direction (H). The process direction (P) may then extend along this length, wherein the material flow (molten plastic mixture) is transported along this process direction through the centrifuging region. This may have the advantage that the plastic fractions can be separated especially efficiently and reliably along this transport length (see FIG. 16 and FIG. 17). In an embodiment, the centrifuging region or the centrifuging device is configured as an elongate container, wherein one side wall or multiple side walls delimit an (centrifuging material) interior space. The container may be configured to be round (tubular) or (right-) angular in cross-section, for example. In this context, the term “elongate” may relate in particular to an object such as a container having a preferred direction or a main extension direction along which this object (this container) extends.

In a specific embodiment, the centrifuge may have a rotational speed in the range up to 3000 rpm. The container may have a length of approximately 1 m and a diameter of 10 cm on a laboratory scale. In an example, the rotational speed may be adapted for a certain plastic mixture and then reused for similar applications.

According to a further embodiment, the discharge region comprises: a first opening for discharging the plastic fraction and/or a second opening for discharging the at least one further second plastic fraction. This may have the advantage that the plastic fractions can be discharged substantially without further aids directly from the centrifuging region (e.g. via the side wall and/or the base region). The openings may preferably be oriented towards a collecting device. For example, each opening may open into a separate collecting device in order to thereby provide separated plastic fractions. Furthermore, the openings may be provided with a drain device (e.g. trenches) in order to conduct the (continuous) molten plastic fraction flow.

According to a further embodiment, the discharge region with the first opening and/or the second (or at least one further) opening is arranged perpendicular to the main extension direction of the elongate centrifuging region. The molten plastic mixture moves during the centrifuging along a process direction through the centrifuging region. Downstream of the process direction, the separation of the plastic fractions may be most reliable, so that openings can be efficiently provided in this end region or bottom region of the centrifuging device. For example, the openings may be arranged in a region which is arranged perpendicular to the process direction (material flow). In the case of an elongate container, this may be e.g. a plate with at least two openings, e.g. a sieve plate (see FIG. 12 and FIG. 13). The axes of the holes are in an example parallel to the process direction and/or parallel to the rotational axis of the centrifuge.

According to a further embodiment, the discharge region with the first opening and/or the second opening is arranged (substantially) parallel to the main extension direction of the elongate centrifuging region. This example may relate in particular to an embodiment in which the openings are associated with or formed in a boundary surface (in particular side wall) of the centrifuging region (in particular of the elongate container). In addition, a side wall, in particular the bottom surface, which is not arranged parallel to the main extension direction of the container may also be effected here. The openings may be associated with a discharge region, so that this discharge region or multiple discharge regions may be located on the container side wall. In an example, a discharge region or multiple of these discharge regions is or are arranged in the end region of the centrifuging region (see FIG. 14). In a further embodiment, a discharge region/opening or multiple (or a plurality of) discharge regions/openings is or are formed along the longitudinal extension (main extension direction) of the elongate container, in particular associated with the side wall (see FIG. 5).

According to a further embodiment, the centrifuging region comprises at least one discharge region with at least one opening in a side wall, through which opening at least one plastic fraction can be separated.

According to a further embodiment, the centrifuging region (or elongate container) along the main extension direction (H) comprises a discharge region with a plurality of openings in a side wall, through which openings a plurality of different plastic fractions can be separated and/or discharged.

According to a further embodiment, the discharge region comprises three or more, in particular five or more, further in particular ten or more, openings. A plurality of discharge (partial) regions may also be provided (e.g. three or more, in particular five or more, further in particular ten or more), each of which comprises an opening or multiple openings. In particular, the device is configured to discharge a different plastic fraction at each opening. This can enable an efficient separation and sorting.

The inventors have surprisingly recognized that a separation/discharge of (at least partially molten) plastic fractions along the process direction (or along an elongate centrifuging container, in particular via the side walls) can enable a particularly efficient and reliable separation.

According to a further embodiment, the plastic mixture comprises a multilayer film and/or a polymer alloy. Such non-sortable mixtures can scarcely be separated with conventional methods and the described device can be particularly helpful for these materials.

According to a further embodiment, the plastic mixture comprises at least one of the following plastics: polyethylene, PE, polystyrene, PS, polyester, PE, polypropylene, PP, polyamide, PA, polyvinyl chloride, PVC, polylactic acid (PLA). Thus, economically especially important and widely used plastics can be suitable for the described separation. Each of these examples may represent a plastic fraction. Furthermore, however, two or more of these plastics can also together form a plastic fraction.

According to a further embodiment, the device further comprises; an electromagnetic device which is configured to provide (directly, selectively) one or more electromagnetic field(s) within the centrifuging region. This may have the advantage that further efficient separation mechanisms can be used (e.g. magnetically). In an example, the electromagnetic field is used directly in the centrifuging region, e.g. by means of an induction device (see also FIG. 6 and FIG. 7). In another example, a magnetic separation can also be carried out with regard to the plastic mixture or the plastic fractions. In an embodiment, alternating poles can be used.

In an example, a DC magnetic field (with north pole and south pole) can deflect electrically charged (Coulomb charge) plastic particles in the rotating material flow, wherein a different (magnitude of) charge can result in a different deflection (Lorentz force=q*(v×B)) in the magnetic field.

In an example, (electro-)magnetic fields are induced, so that differently electrically charged plastics can be separated. In an embodiment, the rotational movement can be adjusted in order to cause a separation due to a different force effect on the charged plastic particles with different electronegativity at the top/bottom of the centrifuging region (two separation steps).

In another example, the magnetic separation can be achieved during the rotation. Thus, a further force (electrostatic/electrodynamic) is used synchronously with the rotation and the centrifugal force is thereby increased (one separation step).

According to a further embodiment, the device is further configured to provide a fractional crystallization (by temperature gradients) within the centrifuging region. This may have the advantage that certain plastic materials or plastic fractions can be separated especially efficiently by (at least partially) crystallizing them, while other plastic fractions do not crystallize.

According to a further embodiment, the method comprises: (continuously) moving (transporting) the plastic mixture perpendicular to the direction of gravity (G). In this embodiment, the process direction runs in the horizontal direction or along the x- or y-axis, in other words: laterally or substantially parallel or tangentially to the earth's surface.

According to a further embodiment, the method comprises: (continuously) moving (transporting) the plastic mixture (substantially) parallel to the direction of gravity (G). In this embodiment, the process direction runs in the vertical direction or along the z-axis, in other words: from top to bottom, or from bottom to top or normal to the earth's surface.

Depending on spatial circumstances or desired results, different modes of operation may be especially advantageous. In an example, however, the process direction (or the centrifuging region) may also be designed to be tilted or pivotable, e.g. in the range 1-89° with respect to the direction of gravity (0° and 90° would correspond to the designations vertical and horizontal).

According to a further embodiment, the method further comprises: laterally discharging, with respect to the main extension direction (of the elongate container), at least one plastic fraction from the elongate centrifuging region, in particular through respectively at least one opening in the side wall of the centrifuging region.

According to a further embodiment, the method comprises: providing at least one already separated plastic fraction to a further separation step, in particular comprising: again centrifuging the separated plastic fraction and thereby further separating the separated plastic fraction into a further first plastic fraction and a further second plastic fraction.

The further centrifuging step can be carried out by a comparable (or the same) device. The further centrifuging step can continuously follow the described separation method or be carried out batch-wise. In an example, the at least one separated plastic fraction is at least partially (still) molten when it is fed to the further centrifuging step. In another example, the at least one separated plastic fraction is cooled and must be (at least partially) molten again before it is fed to the further centrifuging step.

In a further embodiment, the volume flow (the separated plastic fraction) in the (respective) discharge region is assigned in a fraction-dependent manner. In particular, the device comprises a sensor device which is configured to determine a characteristic of the discharged separated plastic fraction. For example, a scale or other sensor device may determine the density of the fraction and additionally control one or multiple switches depending on the detected characteristic (color, density, etc.) of the discharge volume flow.

In an example, a plastic fraction is discharged at two or more discharge regions. These partial fractions may be combined in a further step.

In an example, during the supply of the plastics (into the introduction region), attention is paid to the most homogeneous possible mixing of the plastic fractions to be separated (e.g. multilayer films of constant composition, or admixture of known input fractions as auxiliary separators).

It should be noted that embodiments of the disclosure have been described with reference to different objects. In particular, some embodiments have been described with reference to method claims, while other embodiments have been described with reference to device claims. However, a person skilled in the art will learn from the above and the following description that, unless stated otherwise, in addition to any combination of features which belong to a type of object, also any combination of features which relate to different objects is considered to be disclosed by this document. This also applies in particular between features of the method claims and features of the device claims.

The above-defined aspects and further aspects of the present disclosure result from the examples of the embodiments to be described below and are explained with reference to the examples of the embodiments. The disclosure is described in more detail below with reference to embodiments to which the disclosure is not restricted, however.

### BRIEF DESCRIPTION OF THE DRAWINGS

FIG. 1 and FIG. 2 each show a device according to an exemplary embodiment of the disclosure.

FIG. 3 shows a device with a conveying device according to an exemplary embodiment of the disclosure.

FIG. 4 shows a device with a furnace according to an exemplary embodiment of the disclosure.

FIG. 5 shows a device with lateral discharge regions according to an exemplary embodiment of the disclosure.

FIG. 6 and FIG. 7 each show a device with an electromagnetic device according to an exemplary embodiment of the disclosure.

FIG. 8b, FIG. 9b and FIG. 10 and FIG. 11 each show a feed region according to an exemplary embodiment of the disclosure.

FIG. 12 and FIG. 13 each show a discharge region according to an exemplary embodiment of the disclosure.

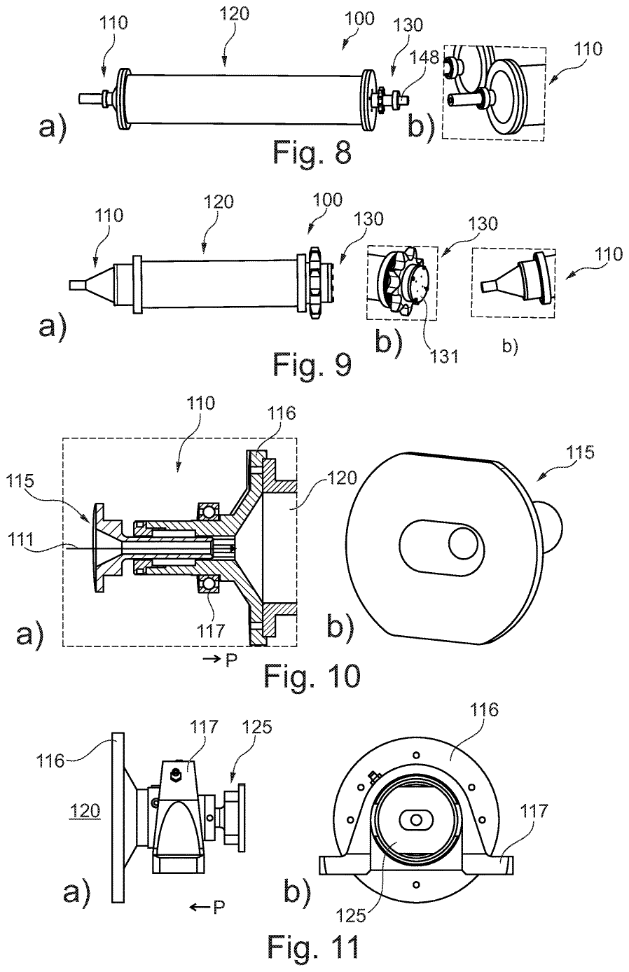

FIG. 8a, FIG. 9a and FIG. 14 show a tubular centrifuging region; and FIG. 9c shows such a region with lateral discharge regions according to an exemplary embodiment of the disclosure.

FIG. 15 shows a (FIG. 15b cooled) coupling region according to an exemplary embodiment of the disclosure.

FIG. 16 and FIG. 17 each show a separation of a plastic mixture into different plastic fractions according to an exemplary embodiment of the disclosure.

### DETAILED DESCRIPTION OF THE DRAWINGS

The illustrations in the drawings are schematic. It is pointed out that, in different figures, similar or identical elements or features are provided with the same reference signs or with reference signs which differ from the corresponding reference signs only within the first digit. In order to avoid unnecessary repetitions, elements or features which have already been explained with reference to an embodiment described above are not explained again at a later point in the description.

Furthermore, spatially relative terms such as “front” and “back”, “top” and “bottom”, “left” and “right”, etc., are used to describe the relationship of one element to another element, as illustrated in the figures. Thus, the spatially relative terms may occur on orientations used which deviate from the orientation illustrated in the figures. Obviously, these spatially relative terms only relate to a simplification of the description and the orientation shown in the figures and are not necessarily limiting, since a device according to an embodiment of the disclosure may assume different orientations than those illustrated in the figures, in particular if it is used.

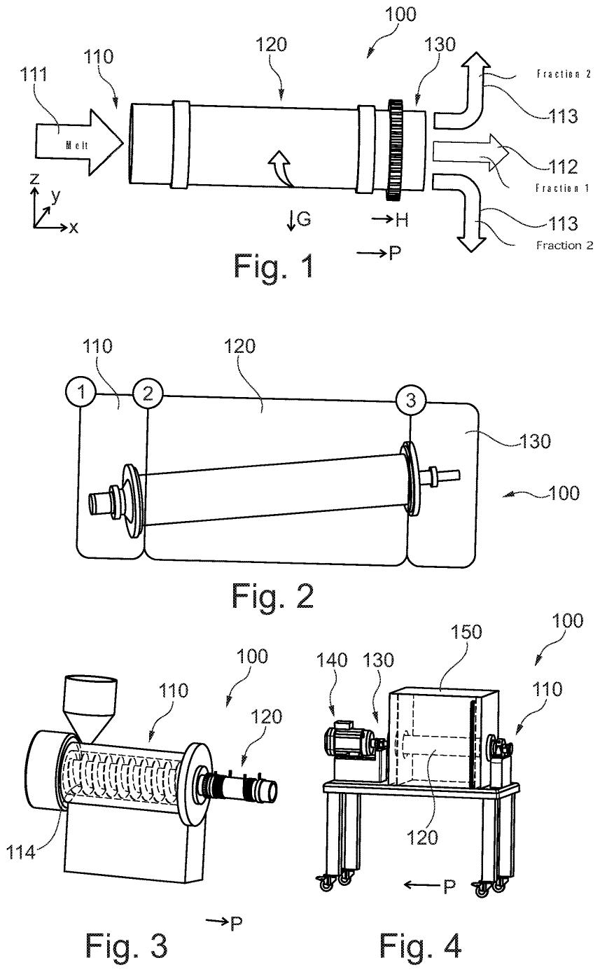

FIG. 1 shows a device 100 for separating a plastic mixture melt 111 according to an exemplary embodiment of the disclosure.

The device 100 has a supply region 110, realized here as an opening in the process direction P upstream of a centrifuging region 120, which is configured to supply the plastic mixture 111 in an at least partially molten state. The centrifuging region 120, here a tubular centrifuge, separates the at least partially molten plastic mixture 111 by means of centrifugal force (rotation schematically illustrated by means of arrow) into a first plastic fraction 112 and a second plastic fraction 113 (wherein the first plastic fraction 112 is different from the second plastic fraction 113, e.g. polyethylene and polylactic acid). A discharge region 130 is shown in this example as an opening of the centrifuging region 120 downstream in the process direction P. The separated plastic fractions 112, 113 can be removed from the device 100 and provided via the discharge region 130. Preferably, the described device 100 is configured to operate in a continuous operation, i.e. continuously supply melt 111, centrifuge it and discharge it.

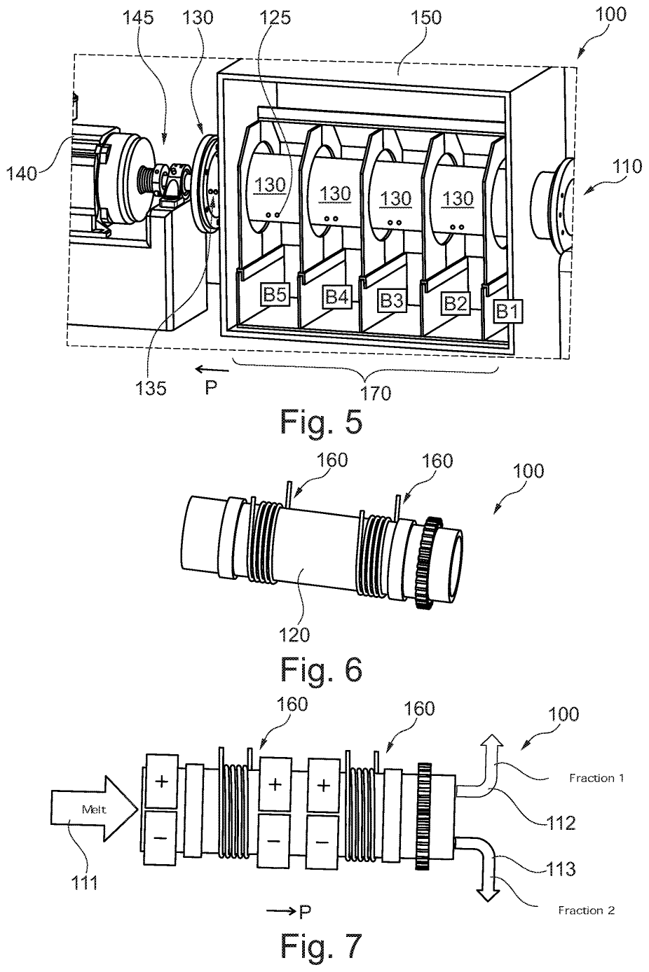

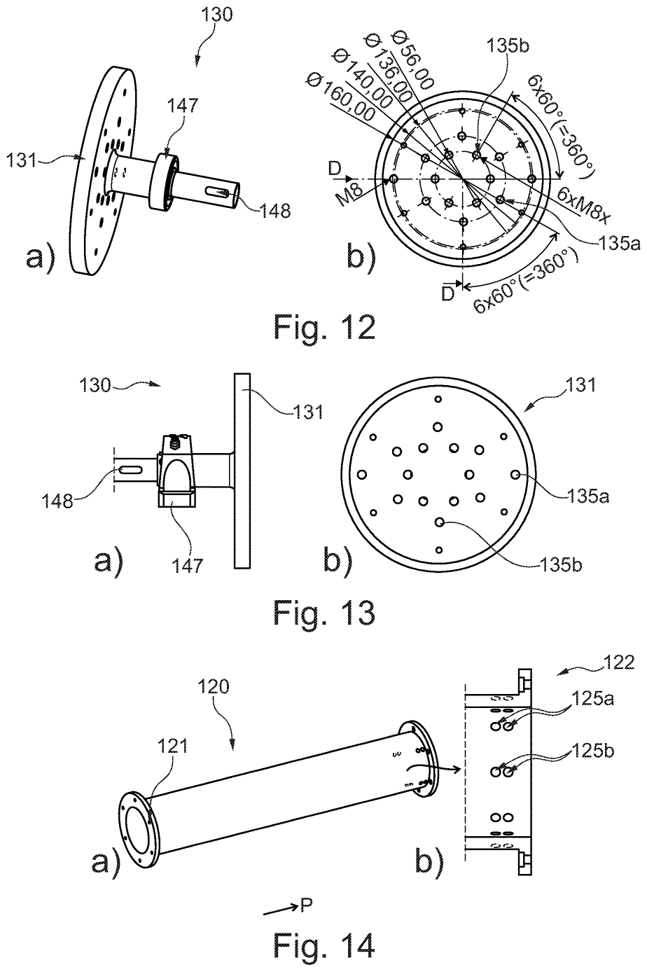

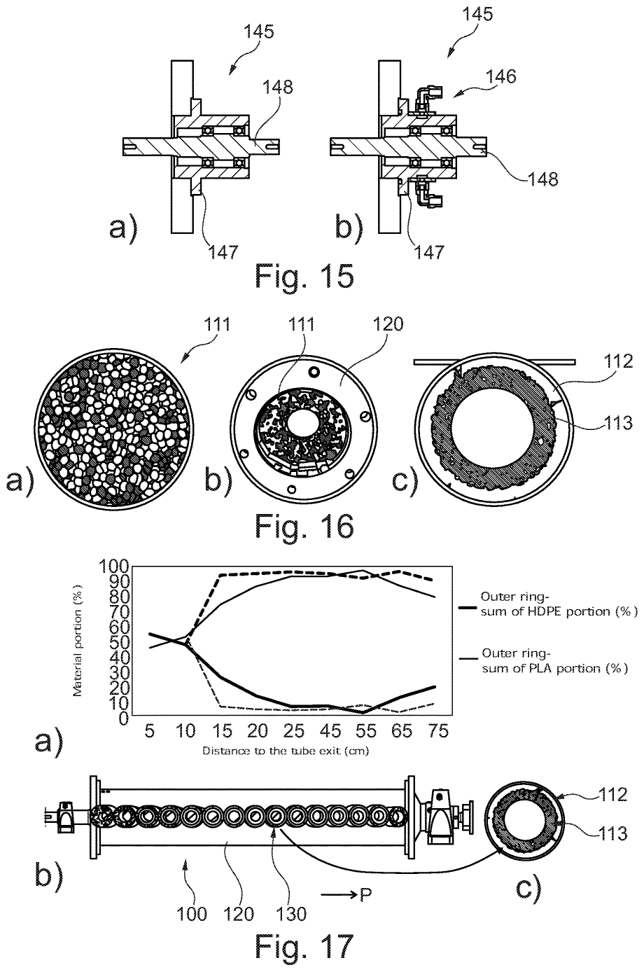

FIG. 2 shows a device 100 for separating a plastic mixture melt according to a further exemplary embodiment of the disclosure. Here, each of the three regions i) feed region 110, ii) centrifuging region 120 and ill) discharge region 130 is formed as a separate device. The feed region 110 has an access (see details in FIG. 8a, FIG. 8b, FIG. 9a, FIG. 9b, FIG. 10a, FIG. 10b, FIG. 11a and FIG. 11b), which has a smaller diameter than the centrifuging region 120 coupled downstream in the process direction P. The discharge region 130 is in turn coupled downstream of the centrifuging region 120 in the process direction P. In this example, the couplings between the regions 110, 120, 130 are each realized via a flange. As shown in the following FIG. 12 and FIG. 13, the discharge region 130 is configured here as a sieve plate 131. Also visible is a drive shaft 148 for the centrifuge 120, which can be coupled to a drive device 140 (see FIG. 4 and FIG. 5).

FIG. 3 shows the device 100 with a conveying device 114 according to an exemplary embodiment of the disclosure. The centrifuging region 120 is coupled to a supply region 110 which comprises a conveying device 114 for continuously providing a molten plastic mixture. In this exemplary embodiment, the conveying device 114 is configured as an extruder (conveying screw).

FIG. 4 shows the device 100 with a furnace 150 according to an exemplary embodiment of the disclosure. In this preferred exemplary embodiment, the centrifuging region 120 is arranged within a furnace 150. The furnace 150 provides a temperature to the centrifuging region 120 such that the plastic mixture substantially remains in the (at least partially) molten state and does not cool down/harden) during the centrifuging. The feed region 110 and the discharge region 130 are arranged outside the furnace 150 in this example. Furthermore, a drive device 140, which is implemented as an electric motor, is shown in this example. A drive shaft (not shown in detail) is connected to the centrifuge 120 via the discharge region 130 and enables the rotation thereof.

FIG. 5 shows the device 100 with a plurality of lateral discharge regions 130 according to an exemplary embodiment of the disclosure. In this embodiment, the device 100 comprises multiple discharge regions 130 next to one another. On the one hand, plastic fractions can be separated downstream in the process direction P via a sieve plate 131. The drive device 140 described above enables the rotation of the centrifuge 120 by means of a drive shaft (mounted at reference numeral 145). The discharge regions 130 are in turn formed as openings 125 in the side wall of the centrifuging device in the centrifuging region 120. Collecting devices 170 are each provided under this plurality of discharge regions 130. In the continuous operation, each of the plurality of discharge regions 130 should enable the discharge of a specific plastic fraction in its respective region B1 to B5, so that a different plastic fraction is then present in each collecting device 170.

FIG. 6 and FIG. 7 each show the device 100 with an electromagnetic device 160 according to an exemplary embodiment of the disclosure.

FIG. 6: the electromagnetic device 160 is configured here as an induction device (coil) around the centrifuging region 120. In this way, an electromagnetic influence can be exerted on the molten plastic mixture 111 within the centrifuging region 120 in specific regions, e.g., a fractional crystallization or a magnetic separation (for plastics with different electronegativity) can thus be carried out.

FIG. 7 shows the device 100 according to FIG. 6 with further details. In particular, the electromagnetic device 160 can generate different electromagnetic fields (schematically illustrated) at different regions of the centrifuge 120. The coil is an indication here for targeted heating, in order thus to achieve targeted temperature control of the process or of the melt. The symbol “+/−” stands by way of example for (electro)magnetic fields which can be additionally provided.

FIG. 8a, FIG. 8b, FIG. 9a, FIG. 9b, FIG. 10a, FIG. 10b, FIG. 11a and FIG. 11b each show a feed region 110 according to an exemplary embodiment of the disclosure.

FIG. 8a: in this embodiment, the feed region 110 has a supply line, the cross-section of which is significantly smaller than that of the centrifuging region 120, into which the supply line opens via an front cover (German: Stirnabdeckung) of the centrifuging region 120. The corresponding discharge region 130 is implemented as a simple sieve plate 131, wherein a drive shaft 148 for the centrifuge 120 runs through this sieve plate 131. FIG. 8b is a detailed illustration of the feed region 110.

FIG. 9a: in this embodiment, the feed region 110 has a conical transition region between the supply line with a smaller cross-section and the centrifuging region 120 with a larger cross-section. The corresponding discharge region 130 has an additional drive docking device (illustrated by way of example here in gearwheel form) in order to enable a drive “from the outside”, with the result that no drive shaft has to be guided through the sieve plate. FIG. 9b is a detailed illustration of the feed region 110 and FIG. 9c is a detailed illustration of the discharge region 130.

FIG. 10 shows the transition between an introduction device 115 of the feed device 110 and the centrifuging region 120. The introduction device 115 is configured as a funnel, through which the molten plastic mixture 111 can be introduced into the region with a small cross-section of the feed device 110. A transition from the non-rotating extruder into the rotating centrifuging region 120 takes place here, wherein a seal is provided. Reference sign 116 denotes a coupling (here flange) between feed device 110 and centrifuging device in the centrifuging region 120 and reference sign 117 denotes a fixing (e.g. ball bearing ring). FIG. 10b shows a detailed illustration of the introduction device 115.

FIG. 11a and FIG. 11b show the feed device 110 according to FIG. 10a once again in different views.

FIG. 12 and FIG. 13 each show a discharge region 130 according to an exemplary embodiment of the disclosure.

FIG. 12a: in this embodiment, the discharge region 130 comprises a sieve plate 131, in which the openings 135a and 135b for discharging the plastic fractions are provided. The above-described drive shaft 148 of the drive device 140 (not shown here, see FIG. 4, and FIG. 5) runs through the sieve plate 131.

FIG. 12b shows a schematic illustration of the distribution of the openings 135a and 135b (here at constant angular distances and two different radial distances from the rotational axis). In addition to the openings for the separation, further openings are provided for fastening purposes.

FIG. 13a and FIG. 13b show further views of the sieve plate 131 and of the openings 135a and 135b.

FIG. 14a shows a tubular centrifuging region 120 with lateral discharge regions according to an exemplary embodiment of the disclosure. Upstream in the process direction P, the centrifuging region 120 has a coupling region 121 for a feed device, while the centrifuging region 120 has a coupling region 122 for a discharge device downstream in the process direction. In the latter coupling region 122 (see FIG. 14b), openings 125a, 125b are provided in the side wall of the centrifuging region 120, which can be associated with a discharge region. These openings 125a, 125b enable a discharge of specific plastic fractions.

FIG. 15 shows a coupling region 145 according to an exemplary embodiment of the disclosure. This coupling region 145 between drive device and centrifuging region (via the discharge region), e.g. by means of drive shaft 148, can be thermally challenging for the drive device. In the exemplary embodiment shown in FIG. 15b, this problem can be overcome by means of a cooling device 146, realized here by means of a coolant flow.

FIG. 16 shows the separation of a plastic mixture 111 into different plastic fractions 112, 113 according to an exemplary embodiment of the disclosure before and after centrifuging.

FIG. 16a: illustrated graphically, the plastic mixture 111 comprises a first plastic fraction 112 (white) and a second plastic fraction (black).

FIG. 16b: the view into the centrifuging region 120 shows that the (molten) plastic mixture 111 is positioned on the side walls after a short rotation time.

FIG. 16c: the view into the centrifuging region 120 after a longer rotation time shows that the plastic fractions 112, 113 have separated into a white outer region 112 and a black inner region 113.

FIG. 17 shows the separation of a plastic mixture into different plastic fractions 112, 113 according to an exemplary embodiment of the disclosure.

The diagram in FIG. 17a shows schematically the demixing course of the plastic fractions 112 and 113 (here PLA and HDPE) along the length of a (tubular) centrifuging region 120. In this example, a laboratory scale is selected.

FIG. 17b shows corresponding images (with respect to the diagram of FIG. 17a) of the plastic mixture 111 at different positions within the elongated centrifuging region 120. A clear separation of the plastic fractions 112, 113 downstream in the process direction P can be achieved.

FIG. 17c shows the demixing at the marked position of the centrifuging region 120 in cross-section at a specific point in time, wherein here the ninth opening of FIG. 17b represents a discharge region from the left, via which the outer ring portion (=that with higher or the highest density) can be discharged (continuously) branching off from the material flow. Ideally, this only occurs until this fraction is no longer represented in the material flow. (Note: the density: HDPA<1 g/cm³, PLA>1.2 g/cm³).

### REFERENCE SIGNS

100 Device
110 Feed region
111 plastic mixture, molten
112 First plastic fraction
113 Second plastic fraction
114 Conveying device, extruder
115 Introduction device, funnel
116 flange
117 Fixing device (in the feed region)
120 Centrifuging region
121 Coupling region supply
122 Coupling region discharge
125 Lateral openings (in the centrifuge wall)
130 Discharge region
131 Sieve plate
135 Discharge openings (for example in a sieve plate)
140 Drive device, motor
145 Coupling region
146 Cooling device
147 Fixing (in the discharge region)
148 Drive shaft
150 furnace
160 Electromagnetic device
170 Collecting devices
P Process direction
B1, B2, B3, B4, B5 Fraction ranges

1.-18. (canceled)

19. A device for separating a plastic mixture, the device comprising:
a supply region which is configured to supply the plastic mixture in an at least partially molten state;
a centrifuging region which is coupled to the supply region and which is configured to separate the at least partially molten plastic mixture by centrifuging into a plastic fraction and at least one further plastic fraction;
wherein the plastic fraction is different from the at least one further plastic fraction; and
a discharge region which is coupled to the centrifuging region and which is configured to provide the separated plastic fraction and the separated at least one further plastic fraction; and
wherein the device is configured to operate in a continuous operation.

20. The device according to claim 19, further comprising a heating device for heating the centrifuging region, wherein the centrifuging region is at least partially arranged within the heating device.

21. The device according to claim 20, wherein the heating device is configured to provide a temperature within the centrifuging region such that the melting state of the at least partially molten plastic mixture is maintained.

22. The device according to claim 19, wherein the supply region comprises a conveying device which is configured to continuously supply the at least partially molten plastic mixture to the centrifuging region.

23. The device according to claim 19, wherein the centrifuging region is configured to be elongate with a main extension direction, H.

24. The device according to claim 19, wherein the discharge region comprises:
a first opening for discharging the plastic fraction, and
a second opening for discharging the at least one further plastic fraction.

25. The device according to claim 24, wherein an interface to the discharge region with at least one of the first opening and the second opening is arranged substantially perpendicular to the main extension direction, H, of the elongate centrifuging region.

26. The device according to claim 25, wherein the discharge region comprises a sieve plate in the end region, with respect to the process direction, P, of the elongate container.

27. The device according to claim 24, wherein the discharge region with at least one of the first opening and second opening is arranged substantially parallel to the main extension direction, H, of the elongate centrifuging region.

28. The device according to claim 19, wherein the discharge region is formed with at least one opening in a side wall of the centrifuging region, and
wherein at least one plastic fraction can be separated through the at least one opening.

29. The device according to claim 28, wherein the centrifuging region along the main extension direction, H, in the process direction, P, comprises the discharge region with a plurality of openings, through which openings a plurality of different plastic fractions can be at least one of separated and discharged, and
wherein the plurality of different plastic fractions comprises the plastic fraction and the at least one further plastic fraction.

30. The device according to claim 24, wherein the discharge region comprises three or more openings, and
wherein the device is configured to discharge a different plastic fraction at each opening.

31. The device according to claim 19, comprising at least one of:
wherein the plastic mixture comprises multilayer film material; and
wherein the plastic mixture comprises at least one of the following plastics:
polyethylene, PE, polystyrene, PS, polyester, PE, polypropylene, PP, polyamide, PA, polyvinyl chloride, PVC, polylactic acid, PLA.

32. The device according to claim 19, further comprising an electromagnetic device which is configured to provide an electromagnetic field within the centrifuging region.

33. The device according to claim 19, further configured to provide a fractional crystallization within the centrifuging region.

34. A method comprising:
at least partially melting a plastic mixture;
centrifuging the at least partially molten plastic mixture and thereby separating the at least partially molten plastic mixture into a plastic fraction and an at least one further plastic fraction;
wherein the plastic fraction is different from the at least one further plastic fraction; and
discharging the separated plastic fraction and the separated at least one further plastic fraction; and
wherein the method is operated continuously.

35. The method according to claim 34, wherein the centrifuging is carried out in an elongate centrifuging region, and wherein the method comprises:
continuously moving the plastic mixture in a process direction, P, substantially perpendicular to the direction of gravity; or
continuously moving the plastic mixture in a process direction, P, parallel to the direction of gravity, G.

36. The method according to claim 35, further comprising laterally discharging, with respect to the main extension direction, H, at least one plastic fraction from the elongate centrifuging region.

37. The method according to claim 34, further comprising providing at least one separated plastic fraction to a further separation step.

38. The method of claim 37, further comprising centrifuging this at least one separated plastic fraction and thereby separating the separated plastic fraction.
